(19) United States
(12) Patent Application Publication
(10) Pub. No.: US 2008/0313732 A1
(43) Pub. Date: Dec. 18, 2008

(54) Preventing the theft of protected items of user data in computer controlled communication networks by intruders posing as trusted network sites

(75) Inventor: Justin Monroe Pierce, Cary, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Research Triangle Park, NC (US)

(21) Appl. No.: 11/741,326

(22) Filed: Jun. 14, 2007

(51) Int. Cl. G06F 17/00

(52) U.S. Cl. 726/22

(57) ABSTRACT

Theft of protected items of user data from intrusion and theft, e.g. phishing in protected by maintaining a first listing, associated with said with a user display terminal, of protected user data items; and maintaining a second listing, associated with the display terminal, of the addresses of trusted network sites to which each of said protected user data items may be transmitted. The when a there is an initiation of a transmission of a protected item from said user display terminal to a selected non-trusted network site as determined by comparison of the two lists, the user is given an alert of his proposed transmission to a non-trusted site. The transmission is prohibited until the user decides to either cancel or proceed with the transmission.

### TECHNICAL FIELD

The present invention relates to computer managed communication networks, such as the World Wide Web, and particularly to preventing the theft of protected items of user data through intruders posing as user trusted network sites, e.g. by “phishing”.

### BACKGROUND OF THE INVENTION

The past generation has been marked by a technological revolution driven by the convergence of the data processing industry with the consumer electronics industry, and the commercial and banking industries distribution of commercial transactions known as E-commerce. The effect has in turn driven technologies which have been known and available but relatively quiescent over the years. A major one of these technologies is the internet related distribution of documents, and commercial transactions including monetary transactions.

With the development of these industries, as network thieves became more sophisticated in the theft of valuable data through data processing ploys, they were met with continuously more and more sophisticated firewalls, encryption techniques, and identification expedients. As a result, theft of data via data processing transactions on public and private networks has become increasingly more difficult. At the present time, theft by data processing techniques requires complex efforts by thieves having a considerable amount of computer skills. As a result, the focus of data theft via networks such as the Web has shifted to a less sophisticated and easier to proliferate scheme known as phishing.

Any would-be thief with only limited computer skills can become a phisher. In phishing, the intruder does not target the data itself with data processing techniques. Rather, the phisher targets the user with the hope that either fear, panic, or greed will lure the user into giving away significant items of his protected data. Typically, the phisher copies and forges a trusted site Web page. This is sent to many users. The page appears to be a trusted-site Web page in which user protected information such as credit card numbers, bank account information including passwords, social security numbers, and other personal information used for confirmation purposes is solicited via requested data entry by the user. The phisher will send a Web page or electronic document which is forged so as to appear to be a page or communication from a trusted site to up to potentially thousands of clients and customers of the trusted institution site in a blanket e-mail transmission. General customer or client lists are accessible through the data processing underworld. The phisher uses such lists in a broad general distribution via the Web to the targeted users. Actually, it is not unusual for a phisher to send out millions of e-mail messages forged to look like a message from a selected major bank, with the intent that statistically it will reach a set of the distribution which has accounts with the bank. While most users have become relatively sophisticated in eliminating or ignoring such phishing mail, each e-mailing is likely to ensnarl several receiving users. As the users become more sophisticated, so do the phishing schemes. They try to panic their targets into responding by threats that their accounts are being cleaned out and an immediate response is imperative. Other phishing schemes “slow play” the targets through a series of communications over a sequence of days or hours with an initial communication indicating suspicious activity relative to the account, followed by notification of some small transactions, followed by notification that some of the user's checks are being returned because of insufficient funds.

While such phishing activity is criminal, and laws have been specifically directed at phishing, the activity is rapidly expanding. The criminal sites are often at remote world wide locations, safe from local or national law enforcement. Each originating criminal site is shortlived: the phisher typically moves in, quickly harvests whatever protected data is forthcoming, steals what is accessible from accounts, and moves on to create another site from a different remote address on the Internet. Phishing has become so pervasive that many commercial and financial organizations can no longer use e-mail for general distribution of general information. Even e-mail notices from trusted institutions which do not solicit customer data are regarded with suspicion. The problem has reached the point that a great many commercial and financial institutions are advising customers to ignore all e-mail purportedly coming from the institution. Phishing has become an obvious blot on e-commerce and banking.

### SUMMARY OF THE INVENTION

The problems created by phishing are of course being extensively addressed by the commercial and banking institutions, the government, and law enforcement. While the present invention does not purport to offer a complete solution to phishing, it does provide an implementation which solves an important aspect of protection against phishing.

The invention provides an implementation which gives even the casual and unsophisticated user protection against phishing which is usually transparent to the user and does not require any extra effort on the part of the user until a potential phishing attack is recognized. The invention is directed to the transmission of communications such as e-mail in a network, such as the Web, of sites from which Web pages may be transmitted to the users at receiving computer controlled display terminals. The invention involves maintaining a first listing, associated with the user display terminal, of protected user data items; and maintaining a second listing, associated with the display terminal, of the addresses of trusted network sites to which each of the protected user data items may be transmitted. Then, when a there is an initiation of a transmission of a protected item from the user display terminal to a selected non-trusted network site as determined by comparison of the two lists, the user is given an alert of his proposed transmission to a non-trusted site. The transmission is prohibited until the user decides to either cancel or proceed with the transmission.

In accordance with aspects of the invention, the user may choose to override the prohibition and proceed with the transmission or the user may be enabled through appropriate display screen dialog to designate the site to be a trusted site. The last implementation enables the user to add new trusted sites to the trusted site list during the user's first initiated transmission to the trusted site.

The invention relies on the ability of the user display terminal, and particularly the Web browser, to inherently recognize the addresses of all received transmissions, and, thus, to determine through the comparison of the two lists that a phishing forged Web page is not from the trusted source.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a very generalized view of a network, e.g. Web, portions showing how a remote intruder source may be set up to pose as a trusted source or site, and forge a Web page allegedly from the trusted site;

FIG. 2 is a generalized view of a typical initial forged Web page received at a user display terminal indicating that the user's bank account is in peril;

FIG. 3 is a generalized view of a second forged Web page which is a follow-up from the phisher into which the user has apparently been tricked to enter his protected password to his account;

FIG. 4 is the view of FIG. 3 after the user has attempted to transmit the password including Webpage back to the suspected phisher; the user is alerted and given options;

FIG. 5 is a block diagram of a data processing system including a central processing unit and network connections via a communications adapter that is capable of functioning as users' receiving display terminals:

FIG. 6 is an illustrative flowchart describing the setting up of the process of the present invention for the prevention of transmission of protected items to non-trusted network sites; and

FIG. 7 is a flowchart of an illustrative run of the process setup in FIG. 6.

### DETAILED DESCRIPTION OF THE PREFERRED EMBODIMENT

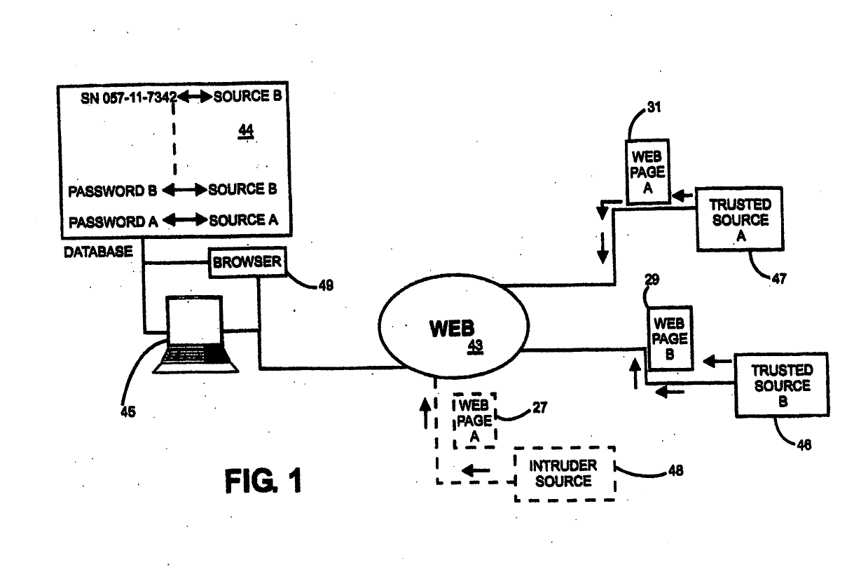

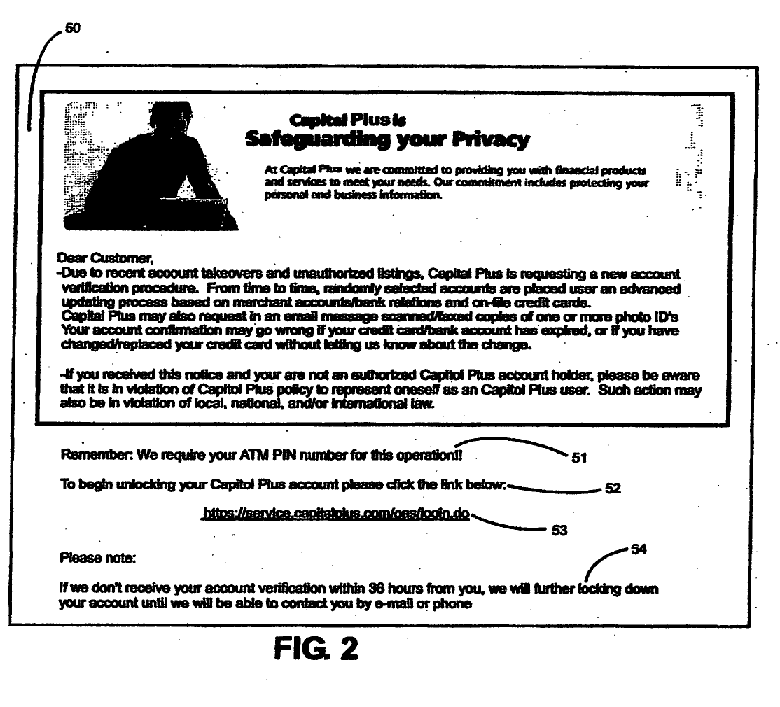

Referring to FIG. 1, there is shown a very generalized diagram of a Web portion on which the present invention may be implemented. Receiving user computer terminal 45, having a user interactive display interface controlled by a conventional Web browser program 49 such as the Microsoft® Internet Explorer® is typically connected to the Web 43 via standard Web wired connections through a Web access server that may be provided by a commercial service provider. Reference may be made to the text, Mastering the Internet, G. H. Cady et al., published by Sybex Inc., Alameda, Calif., 1996, particularly pp. 136-147, for typical connections between receiving display terminals to the Web 43. Normally in commercial or financial transactions, the typical user display terminal 45 accesses, via its Web browser 49, Web pages A, 31 and B, 29 respectively from Web sources or sites 47 and 46. Sources 46 and 47 are trusted sites which means that such trusted sites will from time to time require protected data items from the user at receiving terminal 45. It would be advantageous for the commercial and financial trusted sites 46 and 47 to be able to acquire protected data-items from the user at receiving terminal 45. Unfortunately because of phishing, a remote intruder source or site 48 typically generates a forged Web page A 27 which looks exactly like the authentic Web page A 31 from trusted site 47. Thus, when the forged Web page 27 is received at user terminal 45, the not alerted user at terminal 45 can be tricked into believing he is responding to an inquiry from trusted site 47, and thus provide protected items of data such as social security numbers or passwords into data entry dialog box prompts in the forged Web page 27. The present invention prevents this by having a database 44 associated with the receiving terminal. This database stores a first list 64 of protected data items, and stores a second list 65 which for each item of protected data in listing provides the address, e.g. URL of at least one trusted site. As will be subsequently described with respect to FIGS. 2-4, with this arrangement the user may be alerted if the source of a Web page containing protected data items which the user is about to transmit back to is a non-trusted site.

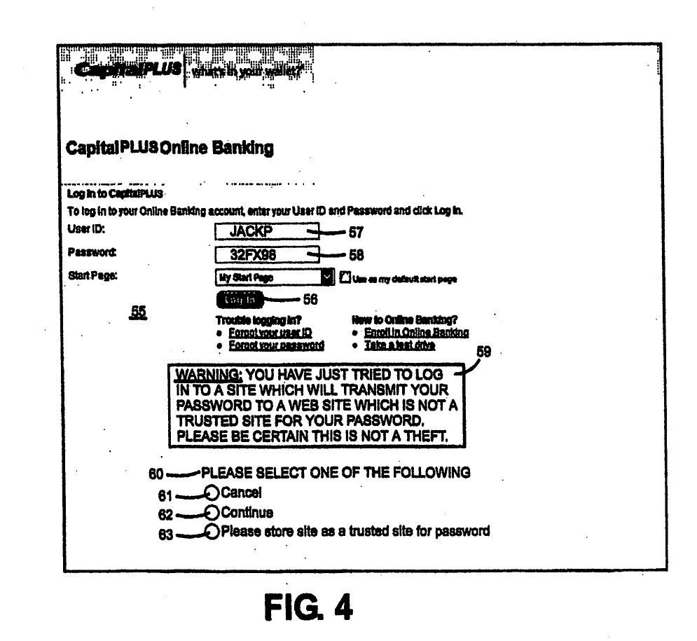

In the installation of the program of this invention at the user receiving terminals, the user is initially prompted to enter and designate his protected data items such as passwords or social security numbers. While this initial entry of passwords would normally also entail an associated trusted site, social security numbers would not have such an associated site. Thus, it may be the case, that upon installation, the only list that has content is the list of protected items. However, as will be subsequently described with respect to FIG. 4, provision is made for the addition of trusted sites, and, thus, the development of the list of such sites.

The Web browser may also be set up to dynamically look for items which may be protected items in E-mail and HTML or Web documents of the user. This may be done by having the browser scan such documents for key terms such as “password” or “SN” which might indicate protected items. Upon finding such a potential protected item, the browser could prompt the user who then could select whether to protect the item. This would serve to develop this list of protected items beyond the initial list.

Since aspects of the present invention are directed to Web documents, such as Web pages, transmitted over networks, an understanding of networks and their operating principles would be helpful. We will not go into great detail in describing the networks to which the present invention is applicable. The Internet or Web is a global network of a heterogeneous mix of computer technologies and operating systems. Objects are linked to other objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images.

Web documents i.e. pages are conventionally implemented in HTML language, which is described in detail in the above-referenced text entitled Just Java, particularly at Chapter 7, pp. 249-268, dealing with the handling of Web pages; and also in the aforementioned text Mastering the Internet, particularly at pp. 637-642, on HTML in the formation of Web pages. In addition, aspects of this invention will involve Web browsers. A general and comprehensive description of browsers may be found in the above-mentioned Mastering the Internet text at pp. 291-313.

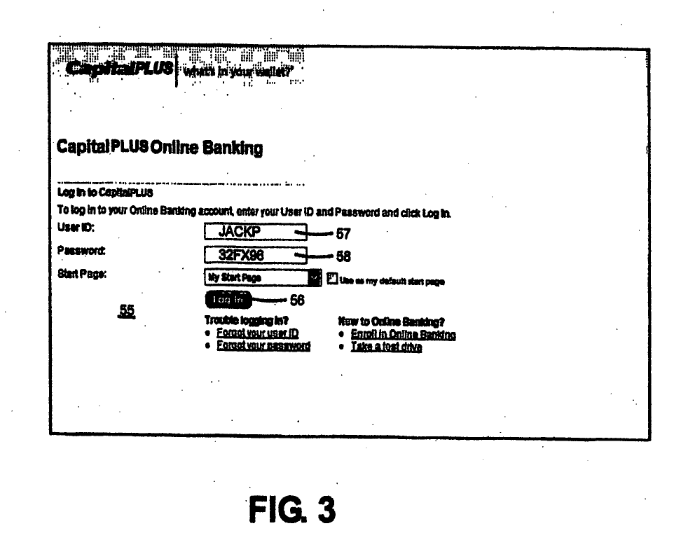

Now commencing with FIG. 2, let us consider how the present invention provides a response to a potential phishing attack. The figure is a generalized view of a typical initial, possibly forged, Web page received at a user display terminal indicating that the user's bank account is in peril. The Web page contains the warning 54 that unless the user responds in 36 hours, his account will be locked down. The user is urged 52 to begin unlocking his account; he is to click on a Web link 53 which appears to be a link to the bank (trusted site) site. The user is further alerted that his PIN number will be required 51. A user, unsophisticated to the dangers of network phishing, may click on link 53 which in turn will display a subsequent Web page 55 shown in FIG. 3. On this Web page, the unsophisticated user has been possibly tricked into entering protected items, at least his password 58 in addition to his user ID 57. Now, the user clicks on Log In button 56 which will initiate the transmission of the item of protected data to a potentially forged user trusted Web site. At this point, the process in the Web browser by comparing lists 64 and 65 (FIG. 1), determines that the password 58 is a protected item, and that the proposed transmission to the intruder source 48 (FIG. 1) is to a source the address of which is not listed as a trusted site or source to which the password may be transmitted to. Accordingly, a routine in the Web browser 49 prohibits the transmission, and displays the warning dialog box 59 (FIG. 4). The user is given three options 60, cancel 61, continue with the transmission 62, or store the address of site as a trusted site for the password item 63, in which case, the transmission will also continue. Even though in the current example, there is an apparent threat for theft, it will be understood that under certain circumstances, the user may wish to transmit protected items of data such as a password to a new site which not been previously associated as a trusted site for the password. In such a case, this dialog permits the user by the selection 63 to establish a new trusted site, and add the trusted site address to list 65 in database 44, FIG. 1. Consequently, the transmission is permitted.

While the above embodiment describes a browser routine in which the comparison of a protected item with the trusted site list is made at the point when the document with the protected item is about to be sent to an alleged trusted Web site, the comparison may be made earlier, e.g. by a Web browser routine at the point that the user keys the actual entry into the document. It is recognized that phishers have become so sophisticated in countering protective methods that the phisher may have a program which encrypts the entry as soon as it is keyed in so that by the time the Web page is to be sent, the item of protected data is no longer recognizable. Monitoring the actual keystroke entries counters such phisher methods.

With increased phisher sophistication, the forged document soliciting user protected items may send the items to a destination address which is different than the origin address of the forged document. Thus in determining the address of the alleged site in question, it is important that the address be the destination address of the solicited protected item. The browser can be programmed with a routine for determining the true destination sites from the contents of the soliciting Web page.

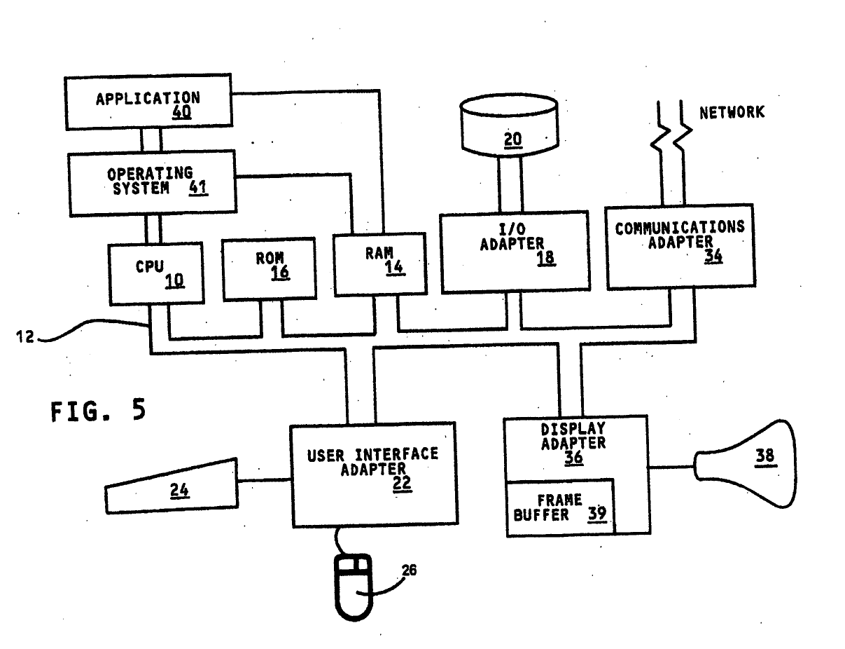

Referring to FIG. 5, a typical data processing unit is shown that may function as the receiving display terminal 45 for receiving the Web documents such as Web pages from Web sites via Web service providers, and for displaying such Web pages. A central processing unit (CPU) 10, such as any PC microprocessor in a PC available from International Business Machines Corporation (IBM), Lenovo Corporation or Dell Corp., is provided and interconnected to various other components by system bus 12. An operating system 41 runs on CPU 10, provides control and is used to coordinate the function of the various components of FIG. 1. Operating system 41 may be one of the commercially available operating systems such as Microsoft's WindowsXP™, as well as UNIX or IBM's AIX operating systems. Application programs 40 running on the data processing system run in conjunction with operating system 41 and provide output calls to the operating system 41, which in turn implements the various functions to be performed by the application 40. The programs and routines of the present invention, for the prevention of transmission of protected data items from the receiving display terminal to non-trusted Web to be subsequently described in greater detail, are among these application programs. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 communicates with the disk storage device 20, i.e. a hard drive. Communications adapter 34 interconnects bus 12 with an outside network enabling the data processing system to communicate with other such systems over a Local Area Network Wide Area Network which includes, of course, the Internet. I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. Display adapter 36 includes a frame buffer 39, which is a storage device that holds a representation of each pixel on the display screen 38. Images may be stored in frame buffer 39 for display on monitor 38 through various components such as a digital to analog converter (not shown) and the like. By using the aforementioned mouse or related devices, a user is capable of inputting information to the system through the keyboard 24 or mouse 26 and receiving output information from the system via display 38.

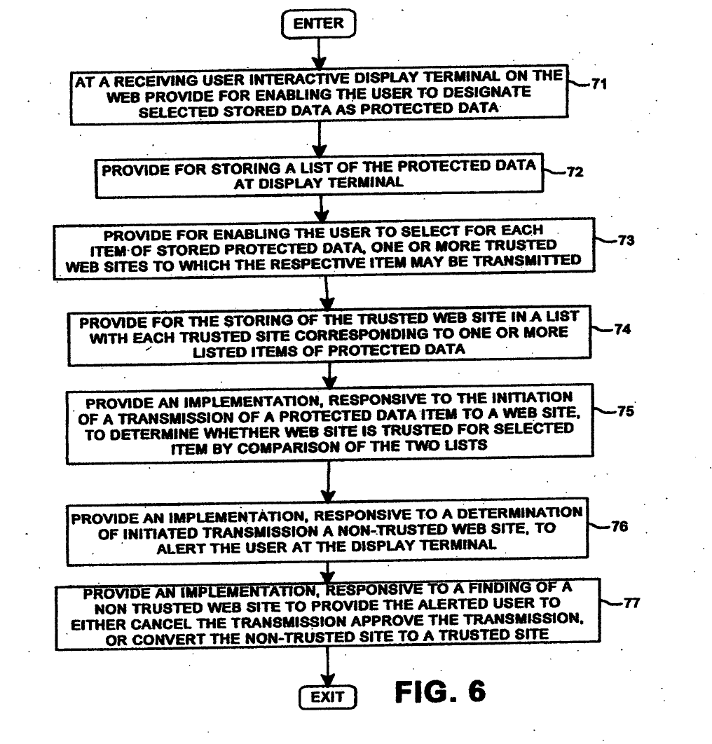

Now, with reference to FIG. 6, there will be described a process implemented by a program according to the present invention for a computer controlled display system during the running of application programs of the present invention. At a receiving user interactive display terminal on the Web, provision is made for enabling he user to designate selected stored data such as passwords as protected data items, step 71. Provision is made for storing a list of such protected items in association with the terminal, step 72. Provision is made for enabling a user to select for each item of stored data, one or more trusted Web sites to which the respective protected item may be transmitted, step 73. Provision is made for the storing of the address of each trusted Web site in a list with each trusted Web site corresponding to one or more listed items of protected data, step 74. An implementation is provided, responsive to the initiation of a transmission to a Web site, to determine whether the Web site is trusted for the selected item by comparison of the two lists, step 75. An implementation is provided, responsive to a determination of an initiated transmission to a non-trusted Web site, to alert the user at the display terminal, step 76. There is also provided an implementation, responsive to a finding of a non-trusted web site, to provide the user with a dialog to either cancel the transmission, approve the transmission, or convert the non-trusted site to a trusted site, step 77.

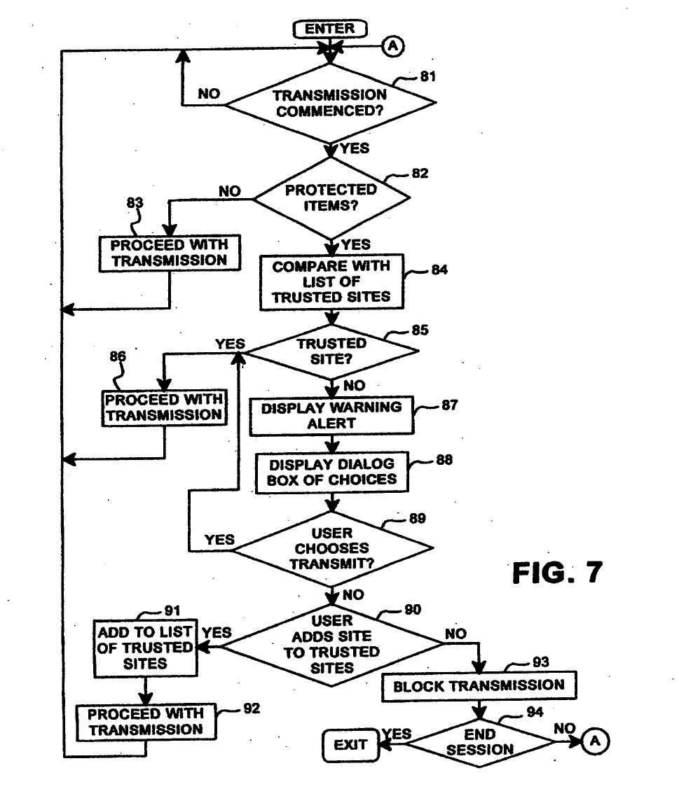

Now that the basic process has been described and illustrated, there will be described with respect to FIG. 7 a flow of a simple operation showing how the program could be run. With the user at the terminal, an initial determination is made as to whether a transmission from the display terminal has been commenced, step 81. If Yes, then a further determination is made as to whether there are any protected items, step 82. If No, then the transmission is conventionally continued, step 83. If Yes, a comparison is made with the list of trusted sites, step 84, and a determination is made as to whether the site to which the protected item is to be transmitted is a trusted-site for the item, step 85. If Yes, then the transmission is conventionally continued, step 86. If No, a warning alert is displayed, step 87, and the user is given a dialog box of several choices, e.g. dialog box 59-63, FIG. 4, step 88. A determination is then made as to whether the user has chosen to transmit despite the warning, step 89. If Yes, then the transmission is conventionally continued, step 86. If No, a further determination is made as to whether the user has elected to add this site to the list of trusted sites, step 90. If Yes, then the transmission is conventionally continued, step 91. If No, the transmission is blocked, step 93. At this point, a determination is conveniently made as to whether the session is over, step 94. If Yes, the session is exited. If No, the session is branched back to step 81 via branch “A”.

One of the implementations of the present invention may be in application program 40 made up of programming steps or instructions resident in RAM 14, FIG. 1, of a Web receiving station during various Web operations. Until required by the computer system, the program instructions may be stored in another readable medium, e.g. in disk drive 20 or in a removable memory such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be, understood that many changes and modifications may be made therein without departing from the scope and intent of the appended claims.

What is claimed is:

1. In a network of a plurality of network sites accessible from a plurality of computer controlled user display terminals, a system comprising:
a mechanism associated with a user display terminal for transmitting user data to selected network sites;
a first listing, associated with said with said user display terminal, of protected user data items;
a second listing, associated with said user display terminal, of the addresses of trusted network sites to which each of said protected user data items may be transmitted; and
a mechanism for alerting a user responsive to an intended transmission of a protected item from said user display terminal to a selected non-trusted network site.

2. The network system of claim 1 further including
a mechanism for prohibiting said intended transmission in response to said alerting; and
a display interface enabling said user to override said prohibited transmission.

3. The network system of claim 2 wherein said display interface enables a user to designate said non-trusted source to be a trusted source for said protected item whereby the transmission is achieved.

4. The network system of claim 2 wherein:
the network is the World Wide Web;
said addresses in said second list are the URLs of said trusted sources; and
the non-trusted site is a phisher Web site.

5. The network system of claim 4 wherein:
said protected item is a password; and
said phisher Web site is the source of a Web page falsely aliasing as a Web page from a trusted source to steal the user's password to said trusted source.

6. The network system of claim 4 further including a Web browser including said mechanism for transmitting, said first associated and said second associated listings, and said mechanism for alerting said user.

7. The network system of claim 6 wherein said Web browser further controls a display interface enabling a user to designate said non-trusted source to be a trusted source for said protected item whereby the transmission is achieved.

8. In a network of a plurality of network sites accessible from a plurality of computer controlled user display terminals, a method comprising:
initiating an intended transmission from a user display terminal of user data to a selected network site;
maintaining a first listing, associated with said with said user display terminal, of protected user data items;
maintaining a second listing, associated with said user display terminal, of the addresses of trusted network sites to which each of said protected user data items may be transmitted; and
alerting a user responsive to the intended transmission of a protected item from said user display terminal to a selected non-trusted network site.

9. The method of claim 8 further including the step of
prohibiting said intended transmission in response to said alerting; and
displaying an interface enabling said user to override said prohibited transmission.

10. The method of claim 9 wherein said display interface enables a user to designate said non-trusted source to be a trusted source for said protected item whereby the transmission is achieved.

11. The method of claim 9 wherein:
the network is the World Wide Web;
said addresses in said second list are the URLs of said trusted sources; and
the non-trusted site is a phisher Web site.

12. The method of claim 11 wherein:
said protected item is a password; and
said phisher Web site is the source of a Web page falsely aliasing as a Web page from a trusted source to steal the user's password to said trusted source.

13. The method of claim 11 further including a Web browsing process including said steps for transmitting, maintaining said first associated and said second associated listings, and said alerting said user.

14. The network system of claim 6 wherein said Web browsing process further controls a display interface enabling a user to designate said non-trusted source to be a trusted source for said protected item whereby the transmission is achieved.

15. A computer program comprising a computer useable medium having a computer readable program, wherein the computer readable program when executed on a computer causes a user display terminal in a network to:
initiate an intended transmission from said user display terminal of user data to a selected network site;
maintain a first listing, associated with said with said user display terminal, of protected user data items;
maintain a second listing, associated with said user display terminal, of the addresses of trusted network sites to which each of said protected user data items may be transmitted; and
alert a user responsive to the intended transmission of a protected item from said user display terminal to a selected non-trusted network site.

16. The computer program of claim 15 further causes the user terminal to:
prohibit said intended transmission in response to said alerting; and
display an interface enabling said user to override said prohibited transmission.

17. The computer program of claim 16 wherein said display interface enables a user to designate said non-trusted source to be a trusted source for said protected item whereby the transmission is achieved.

18. The computer program of claim 16 wherein:
the network is the World Wide Web;
said addresses in said second list are the URLs of said trusted sources; and
the non-trusted site is a phisher Web site.

19. The computer program of claim 18 wherein:
said protected item is a password; and
said phisher Web site is the source of a Web page falsely aliasing as a Web page from a trusted source to steal the user's password to said trusted source.

20. The computer program of claim 18 wherein said computer program includes a Web browsing program including said steps for transmitting, maintaining said first associated and said second associated listings, and said alerting said user.
